(19) United States
(12) Patent Application Publication
(10) Pub. No.: US 2007/0170017 A1
(43) Pub. Date: Jul. 26, 2007

(54) Inline skate brake

(76) Inventors: Robert C. Brandriff, Brooklyn, CT (US); Kristen E. Brandriff, Brooklyn, CT (US)

Correspondence Address: MEREK, BLACKMON & VOORHEES, LLC, 673 S. WASHINGTON ST, ALEXANDRIA, VA, 22314, US

(21) Appl. No.: 11/339,719

(22) Filed: Jan. 26, 2006

(51) Int. Cl. F16D 55/36

(52) U.S. Cl. 188/71.5

(57) ABSTRACT

A brake system for wheeled skates includes a wheel, a first shoulder fixed relative to wheel bearings in the axial direction of the wheel, a second shoulder fixed relative to the wheel in the axial direction of the wheel, an axially extending space between the shoulders, and a braking mechanism responsive to the narrowing of the space to brake the wheel. The wheel is axially movable relative to the bearings between a first position, in which the space is relatively narrow and the braking mechanism is engaged, and a second position, in which the space is relatively wide and the braking mechanism is disengaged. The braking mechanism includes a plurality of first disks coupled to rotate with the wheel, and a plurality of second disks coupled such that the second disks cannot rotate with the wheel and are interleaved with the first disks.

### FIELD OF THE INVENTION

The present invention relates to brake systems for wheeled skates, and in particular, inline wheeled skates.

### BACKGROUND OF THE INVENTION

Inline skates have become very popular in the last fifteen years or so, almost completely replacing traditional roller skates as the preferred form of wheeled skates. These skates are enjoyed by a broad cross section of the population for general recreational use, and by specialized other groups for such activities as trick and acrobatic skating, and hockey and other athletic activities.

One problem encountered by virtually all users of inline skates had been the lack of an effective brake system. While prior art brake systems existed for inline skates and roller skates, such systems tended to be simplistic and had major limitations. Then, an effective disk brake system for inline skates, which is disclosed in U.S. Pat. No. 6,102,168, was developed. The brake system comprises a brake module composed of alternating rotating and non-rotating brake disks that are free to move axially. The rotating disks are keyed to grooves within the wheel and rotate with the wheel. The non-rotating disks are coupled to an inner hub that is keyed to the skate frame to prevent rotation. Opposing shoulders in the wheel and inner hub serve to press the disks together through axial movement of the wheel assembly when the skater initiates a braking action by providing a force to the outside of the wheel.

In practice, the design unitizes the wheel, a grooved sleeve, and bearings into a single assembly. The brake module, located internal to the wheel assembly, includes a brake pad between the metal disks and is actuated by the sliding movement of the wheel assembly over the outer surface of the non-rotating inner hub. A slight radial clearance is required between the bearing bore and the inner hub to facilitate this axial movement. A wider than normal space is developed within the skate frame by the extended length of the inner hub to provide space for the motion of the wheel assembly.

The brake system of U.S. Pat. No. 6,102,168 allows for application to the most popular and widely used skate models. However, some skate designs require that the skate frame be modified to allow installation of the components of that brake system. The bearings are fixed to the wheel rather than to the frame, and the wheel and bearings move axially together relative to the inner hub in order to actuate the brake. In order to keep the inner hub and the stationary discs from turning during braking, the shaft has a non-circular configuration that mates with a similar non-circular configuration of an opening in the skate frame. Since standard skate frame openings have circular configurations, modification of the skate frame is required in order to install the brake. This is a problem when one wants to retrofit an existing skate with wheels having brakes. The required wider-than-normal frame space also necessitates modification of most of the skate frames or frame inserts that are currently made and sold. Furthermore, the bearings of the brake of U.S. Pat. No. 6,102,168 protrude slightly from standard wheels, on which the bearings are installed, and the assembly of wheel and bearings will not fit within the frame unless the sides of the frame are spread apart.

In addition, the radial clearance between the relatively sliding surfaces of the bearing bore and the inner hub, if excessive, generates an undesirable clicking or tapping noise with each skating stride. Both of these relatively sliding surfaces are at the inner diameter of the inner race of the bearings and are metal. Furthermore, it is possible for incidental braking to occur during a normal skating motion since no provision is made to bias the system into the free-spin position.

### SUMMARY OF THE INVENTION

The brake system of the present invention expands the range of application of disc brake systems, and eliminates the need for modifying skate frames or frame inserts. Skate wheels employing the present invention can be installed on a conventional skate frame without modifying the skate frame.

In accordance with the present invention, a central, non-circular portion of a spacer supports two interleaved sets of brake disks, a rotating set and a non-rotating set, the disks of the stationary set having non-circular central openings shaped to mate with the non-circular portion to keep the stationary disks from turning. Any tendency for the spacer to turn is counteracted by such turning causing tightening of one of two threaded fasteners securing the spacer to the skate frame.

The brake system includes bearings securable to a skate frame with screws, and the skate wheel slides axially on the outer surfaces of the bearings as the brake is actuated. The fact that the relatively sliding surfaces are at the outer surface of the bearings rather than at the inner diameter of the bearings means that a given manufacturing tolerance between the relatively sliding surfaces is smaller as a percentage of the overall diameter and, thus, has less adverse effect. For example, there is less of a tendency for the skates to click during skating. In addition, one of the relatively sliding surfaces, the wheel, is most commonly plastic. As a result, there is no noticeable clicking in the skates. Furthermore, a bearing-accommodating recess in the inside of the wheel, with respect to the foot of the skater, is sufficiently deep that the bearing it accommodates does not protrude beyond the side of the wheel.

A spring is included to bias the wheel assembly into the free-spin position and thereby prevent incidental braking during a normal skating motion. Instead, a definite brake actuating movement by the skater is required in order to overcome a threshold biasing force of the spring, cause the spring to deform, and allow actuation of the brake. The spring also retains the brake disks and pads within the wheel assembly prior to installation in the skate frame. The spring comprises a thin elliptical element that is “C” shaped as viewed along the major axis of the ellipse.

### BRIEF DESCRIPTION OF THE DRAWINGS

FIG. 1 is a partial sectional view of the brake system of the present invention positioned between spaced portions of the frame of an inline skate;

FIG. 2 is a sectional view of the inline skate wheel and sleeve of the brake system of FIG. 1;

FIG. 3 is an exploded perspective view of the wheel and sleeve of FIG. 2;

FIG. 4 is a perspective view of the wheel and sleeve of FIG. 2 in assembled condition;

FIG. 5 is an enlarged perspective view of the spacer of the brake system of FIG. 1;

FIG. 6 is an exploded perspective view of the spacer of FIG. 5 and a plurality of brake disks of the brake system of the present invention;

FIG. 7 is an enlarged front elevation of a first type of brake disk in the plurality of FIG. 6;

FIG. 8 is an enlarged front elevation of a second type of brake disk in the plurality of FIG. 6;

FIG. 9 is an enlarged front elevation of a spring of the brake system of FIG. 1;

FIG. 9A is an end view of a spring as viewed along the major axis;

FIG. 10 is a partial sectional view of the brake system of the present invention in a normal mode of skating; and

FIG. 11 is a partial sectional view of the brake system of the present invention in a braking mode.

### DETAILED DESCRIPTION OF THE PREFERRED EMBODIMENTS

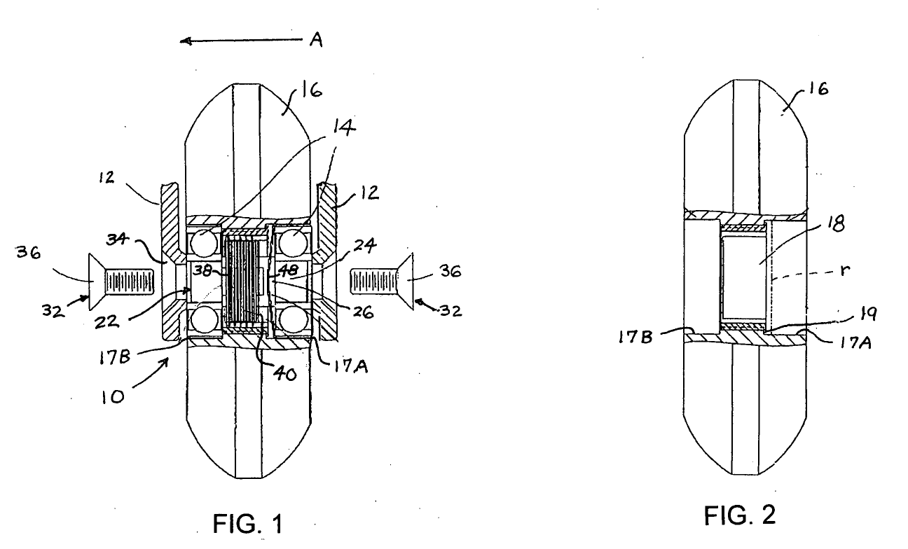

As can be seen from FIG. 1, the brake system for wheeled skates according to the present invention, which is designated generally by the reference numeral 10, includes a bearing arrangement that is adapted to be connected to a skate frame 12, the bearing arrangement comprising spaced bearings 14. A wheel 16 is mounted for rotation and axial sliding on the bearing arrangement, more particularly, on outer surfaces of the bearings 14. Although the outer surfaces the bearings 14 are usually made of metal, the surface of the wheel 16 that contacts the bearings is most commonly made of a plastic. As a result, no clicking sound is produced by the motion of skating. The wheel 16 has a relatively deeper recess 17A on the inside (with respect to the foot of the skater) of the wheel and a relatively shallower, approximately standard depth, recess 17B on the outside of the wheel, each along the axis of rotation of the wheel, and the bearings 14 are positioned in the recesses, the bearing 14 in the recess 17A capable of being entirely accommodated within its recess.

The interior shape and dimensions of the wheel 16 are modified from the skate industry standard. Additional space is provided within the wheel 16 by increasing the depth of the recess 17A on the inner side of the wheel, as shown by broken line ‘r’ of FIG. 2. This additional space allows room for the motion needed for brake actuation. In addition, the diameter of both the inner and outer recesses 17A and 17B in the wheel 16 is increased, for example, from 0.866″ (22 mm) to 0.870″, to allow the wheel 16 to slide across the outer surfaces of the bearings 14 during brake actuation and release.

As can be appreciated from FIGS. 2-4, a sleeve 18 is fixed in a central bore of the wheel 16, such as by a press fit. The sleeve 18 has at one axial end thereof an annular flange 19 extending radially outward to limit movement of the sleeve through the central bore and at the opposite axial end thereof an annular flange 20 extending radially inward to define a shoulder for brake disks, as will be described hereinafter. The shoulder is fixed relative to the bearing arrangement in the axial direction of the wheel 16. The sleeve 18 has axial splines ‘s’ that mate with axial grooves ‘g’ in the bore of the wheel 16 to prevent the sleeve 18 from rotating relative to the wheel. In the present invention, the wheel assembly comprises only the wheel 16 and the sleeve 18, and the axial motion needed for brake actuation and release occurs at the recesses 17A and 17B, between the wheel assembly and the outer surface of the bearings 14. This allows the bearings 14 to be securely retained within the skate frame 12 of FIG. 1, and helps eliminate the noise and excessive free play between the wheel assembly and its supporting arrangement.

As can be seen best from FIGS. 1 and 5, a spacer element 22 has cylindrical end portions 24 sized to be received in central openings in the bearings 14 and an intermediate portion 26 for supporting brake disks, the intermediate portion having a non-circular cross section. In the illustrated embodiment, the intermediate portion 26 has a polygonal cross section, but it could have an elliptical or other non-circular cross section. The cross section of the intermediate portion 26 is larger than the cross sections of the end portions 24 and larger than the central bores in the bearings 14. As a result, the intermediate portion 26 defines shoulders that face axially outward to engage the bearings 14 and maintain the bearings in a spaced relation relative to one another. The spacer element 22, which is preferably made of steel, keeps the axially outer surfaces of the bearings 14 spaced from one another by less than 25 mm. This fixed separation dimension is close to the standard 24 mm (0.945″) frame width, and significantly less than the 25.4 mm (1.000″) inner-hub length used in connection with the brake system of U.S. Pat. No. 6,102,168. Although the standard is 24 mm, skate frames often do not precisely achieve this dimension, with some skate frames being slightly larger than 24 mm and some skate frames being slightly smaller than 24 mm. It has been found that a fixed separation dimension of less than 25 mm, particularly a fixed separation dimension of approximately 24.7 mm, enables the skate wheels 16 employing it to be inserted without difficulty even into skate frames that are slightly less than 24 mm, because the skate frames can be spread apart a small amount relatively easily.

In addition, one end of the intermediate portion 26 includes at least one radially enlarged portion 28 that extends radially outward to define a shoulder that faces axially inward to engage brake disks. In the illustrated embodiment, the intermediate portion 26 includes a plurality of radially enlarged portions 28. Thus, there is an axial space between the shoulder defined by the radially inward extending annular flange 20 of the sleeve 18 and the shoulder defined by the radially enlarged portion 28 of the intermediate portion 26 of the spacer element 22.

In the illustrated embodiment, opposite ends of the spacer element 22 have threaded central bores 30 for receiving threaded fasteners, such as screws 32, in threaded engagement along the axis of rotation of the wheel 16 to secure the spacer element 22 to the skate frame 12, with the bearings 14 clamped between the spacer element 22 and the skate frame. As can be appreciated from FIG. 1, the skate frame 12 has conventional circular openings 34 that receive the screws 32, and the screws have heads 36 that contact outer surfaces of the skate frame. At assembly, the screws 32 are inserted from each side of the skate frame 12 and securely tightened. The screws 32 shown in FIG. 1 are suitable for frames with countersunk screw holes. Other types of common screws are supplied for frames with other hole configurations. Any tendency of the spacer element 22 to rotate tends to tighten one or the other of the screws 32 so that there is no tendency for the assembly to loosen. Tests have shown that the holding power of the screws 32 is substantially in excess of the maximum braking torque that can be developed before the wheel 16 starts to skid on a road or other paved surface.

In another embodiment (not shown), the central bores 30 are shaped as D-D or double D holes, that is, holes that have opposed curved surfaces and opposed rectilinear surfaces, and bolts of mating profile are passed through and secured. Central bores 30 having such a shape can be used with conventional skate frames having on one side an opening large enough to allow the bolt to pass through and on the opposite side a threaded opening that receives the bolt in threaded engagement.

The brake system 10 further includes a braking mechanism responsive to narrowing of the axial space between the shoulder defined by the radially inward extending annular flange 20 of the sleeve 18 and the shoulder defined by the radially enlarged portions 28 of the intermediate portion 26 of the spacer element 22 to brake the wheel 16. As can best be seen from FIGS. 1 and 6-8, the brake system 10 comprises at least two brake disks and preferably two sets of brake disks 38 and 40 that are interleaved with one another and are axially slidable to a slight degree in the axial space. Approximately half of the disks are disks 38, which are keyed to and rotatable with the sleeve 18. The remaining disks are disks 40 are interleaved with the rotating disks 38, positioned around the spacer 22 and configured to be prevented from rotation by the spacer. All of the disks 38 and 40 are preferably made of metal, and brake pads 41 of, for example, a Kevlar-reinforced high-temperature polymer, are positioned between adjacent disks 38 and 40 and slidably mounted on the spacer element 22, so that there is no metal-to-metal contact between brake disks.

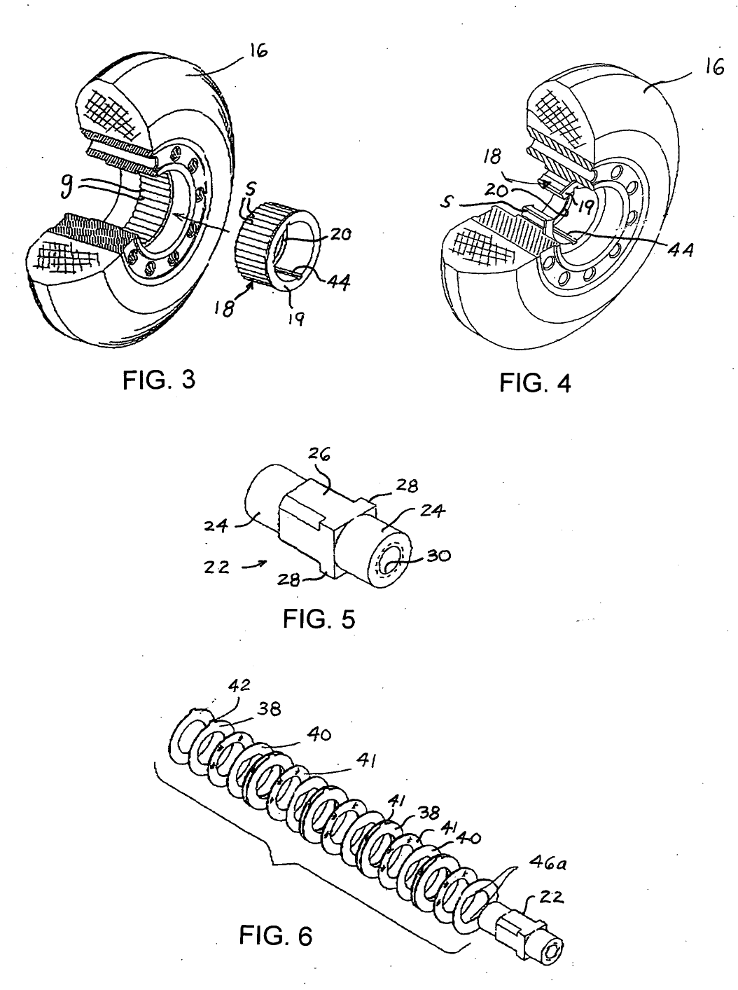

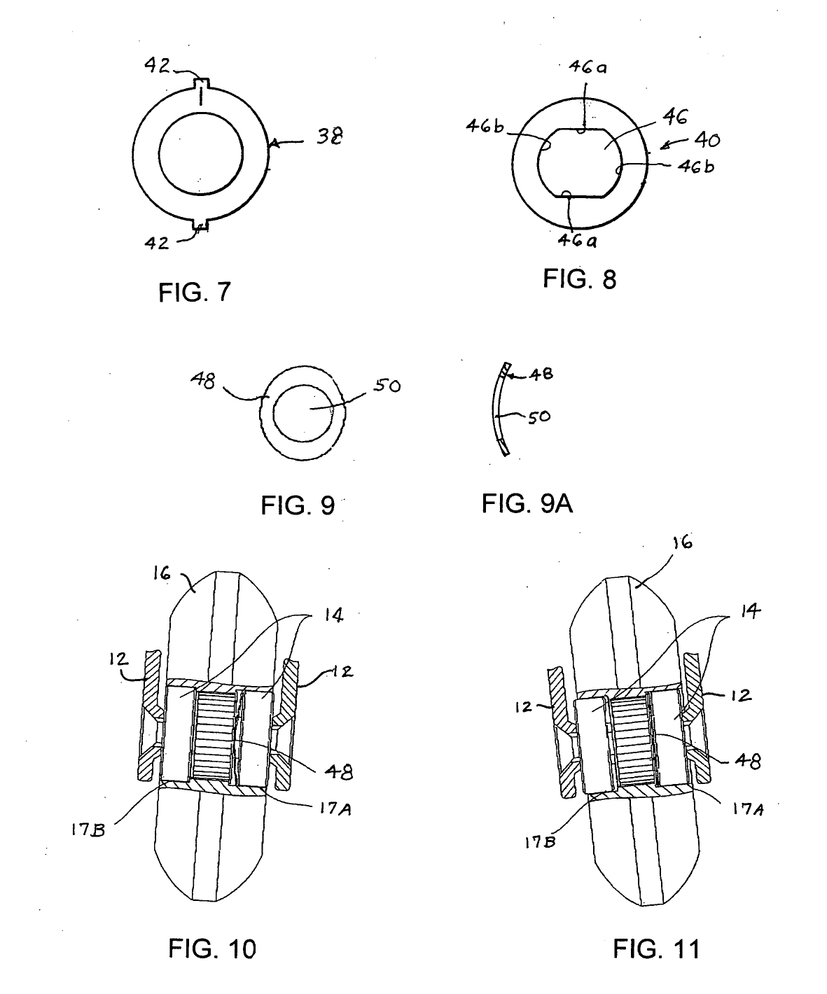

As can be seen from FIGS. 3, 4 and 7, the first set of disks 38 is keyed to the sleeve 18 via retaining tabs 42 on each disk, the tabs best being seen in FIG. 7. The tabs 42 are slidably coupled to wheel 16 through key slots 44 in the sleeve 18. The disk 38 at one axial end of the first set is engaged and axially restrained by the shoulder defined by the radially inward extending annular flange 20 of the sleeve 18. The shoulder is fixed relative to the wheel 16 in the axial direction of the wheel. Although the disks 38 are keyed to the sleeve 18 and rotate therewith, the tabs 42 also can move axially in the slots 44 during skating.

As can best be appreciated from FIG. 8, there are openings 46 in second set of brake disks 40 that receive the intermediate portion 26 of the spacer element 22. The openings 46 have opposed flat surfaces 46a that contact opposed flat surfaces of the polygonal cross section of the intermediate portion 26 such that the spacer element 22 prevents the disks 40 from turning. The openings 46 also have opposed curved surfaces 46b. Openings 46 of other shapes are suitable for cooperating with the polygonal cross section of the intermediate portion 26 of the illustrated embodiment, and openings of still other shapes are suitable for use with intermediate portions of other cross sectional shapes. For example, openings 46 of elliptical shape are suitable for use with an intermediate portion 26 having an elliptical opening. The disk 40 at an axial end remote from the shoulder defined by the radially inward extending annular flange 20 of the sleeve 18 is axially restrained by the shoulder defined by the radially enlarged portions 28 of the intermediate portion 26.

The wheel 16 is axially movable relative to the bearing arrangement between a first position, in which the axial space between the shoulder defined by the radially inward extending annular flange 20 of the sleeve 18 and the shoulder defined by the radially enlarged portions 28 of the intermediate portion 26 is relatively narrow and the braking mechanism is engaged, and a second position, in which the axial space is relatively wide and the braking mechanism is disengaged.

As can be seen from FIGS. 1 and 9, the brake system 10 further includes a spring 48 positioned to bias the wheel 16 toward the said second position, in which the axial space is relatively wide and the braking mechanism is disengaged. The spring 48 has a predetermined threshold force that is required to be overcome before the spring begins deforming to allow movement of the brake disks 38 and 40 toward the first position, in which the axial space is relatively narrow and the braking mechanism is engaged. The spring 48 comprises a thin elliptical element that is “C” shaped as viewed along the major axis of the ellipse and has a central opening 50 that is larger than the radially enlarged portions 28 of the intermediate portion 26 of the spacer 22 but smaller than the outer peripheries of the brake disks 38 and 40. The spring 48 is positioned in the wheel recess 17A after insertion of the brake discs 38 and 40, and the pads 41.

The spring 48 is inserted into the inner recess 17A of the wheel 16 before the spacer 22 and the inner bearing 14 adjacent to the spring are installed. The major axis of the spring 48 is slightly greater than the diameter of the recess 17A, which is conventionally 0.870″, while the minor axis is slightly less than the diameter of the recess 17A. At assembly, the spring 48 is pressed into place with the major diameter positioned across the key slots 44 in the sleeve 18. The slightly greater diameter of the spring 48 holds the spring in place in the recess 17A so that the spring functions to retain the brake assembly in the sleeve 18 during assembly and prior to insertion of the wheel and brake assembly into the skate frame 12. The spring 48 serves to bias the wheel and brake assembly slightly into the non-brake (free-spin) position in order to prevent spurious brake actuation and to provide a predictable threshold point for the start of brake application.

The brake system 10 is incorporated into at least one of the wheels of a skate and preferably into a plurality of the wheels. The brake system of the present invention has been described herein as being incorporated into the wheel system of an inline skate. Alternatively, the brake system of the present invention could be incorporated into a traditional four-wheeled roller skate or still other types of skates.

The brake system 10 functions as follows. When a skater is moving in the normal forward direction, he is either coasting by placing his feet parallel to the direction of travel, or he is actively skating by alternatively pushing out and back using the inside portion of the wheels 16. During coasting, there is sufficient play in the wheels 16 and the disks 38 and 40 that disks 38 freely rotate with wheel 16 and no braking action occurs. During the active skating motion, the skater pushes off and out on the inside portion of wheels 16. This and the force of the spring 48 cause the wheel 16 and the sleeve 18 to move axially towards the outside of the skate, as designated by the arrow A in FIG. 1. This axial motion is permitted by a sliding fit between the recesses 17 in the wheel 16 and the outer surfaces of the bearings 14. The axial movement of sleeve 18 and, thus, the annular flange 20 extending radially inward to define a shoulder increases the axial space between the shoulder and the shoulder defined by the radially enlarged portion 28 of the intermediate portion 26 of the spacer element 22, thereby allowing uninhibited rotation of the disks 38, which is the condition shown in FIG. 10. Consequently, coasting and a normal skating motion disengage the brakes. While there may be some contact among the disks 38 and 40 and the brake pads 41 during the skating motion and during coasting, there is no compression of these elements against one another, and a braking action is therefore not produced.

To brake, the skater must transfer his weight in such a manner that his weight is put on the outside portion of the wheels 16. The skater preferably does this by first pointing his skates parallel to the direction of travel, and then bending his ankles outward so that his weight “rolls onto” the outside portion of his skates. Alternatively, a skater can engage the brake system 10 by pointing his toes slightly inward in a snowplow position. The transfer of the skater's weight to the outside portion of the wheels 16 causes the wheel 16 to compress the spring 48, and after the threshold level of the spring is surpassed, the sleeve 18 and, thus, the annular flange 20 extending radially inward to define a shoulder to move axially toward the shoulder defined by the radially enlarged portions 28 of the intermediate portion 26 of the spacer element 22, which is stationary. The axial movement of the annular flange 20 toward the radially enlarged portions 28 of the intermediate portion 26 of the spacer element 22 narrows the gap between the two shoulders and compresses the disks 38 and 40 and the interposed brake pads 41 against the radially enlarged portions 28. This is the condition shown in FIG. 11. The disks 38 and 40 and pads 41 remain in this compressed position as long as the skater maintains his weight on the outside portion of the skates. When the disks 38 and 40 and pads 41 are compressed in this manner, the rotational speed of disks 38 decreases because of the frictional drag between the disks 38, the brake pads 41 and the non-rotating disks 40. The decrease in rotational speed of disks 38 causes a commensurate loss of rotational speed of the wheels 16, since the disks 38 and the wheel 16 are connected via the tabs 42 and the key slots 44. If the skater maintains the outside pressure on the wheels 16, the disks 38 eventually cease rotating, thereby stopping the wheel 16 from rotating and stopping the skater.

For efficient braking, the brake system 10 should be installed on at least two wheels of a skate. Most inline skates have four wheels per skate, and placing the brake system 10 on the last three wheels is recommended. Furthermore, the selection of suitable materials for the disks, and/or the positioning of materials of a higher/lower friction coefficient between the two sets of disks, allows the range and magnitude of braking force to be controlled. Manufacturing the disks out of readily available spring hardened steel results in effective braking.

While the preferred embodiment of the invention has been described as employing a plurality of disks 38 and a plurality of disks 40, the braking could be achieved with only one disk 38 and one disk 40 with an interposed brake pad 41, as was suggested earlier herein. Other mechanisms could also be used to brake the wheel in response to the narrowing of the axial space between the shoulders.

In the present invention, the wheel assembly comprises only the wheel 16 and the sleeve 18, and the axial motion needed for brake actuation and release occurs at the recesses 17a and 17B, between the wheel assembly and the outer surface of the bearings 14. This allows the bearings 14 to be securely retained within the skate frame 12 of FIG. 1, and helps eliminate the noise and excessive free play between the wheel assembly and its supporting arrangement.

It will further be appreciated by those skilled in the art and it is contemplated that variations to the embodiments illustrated and described herein may be made without departing from the spirit and scope of the present invention. Accordingly, it is intended that the foregoing description is illustrative only, and the true spirit and scope of the invention will be determined by the appended claims.

1. A brake system for wheeled skates comprising:
a bearing arrangement adapted to be connected to a skate frame;
a wheel rotatably mounted on said bearing arrangement;
a first shoulder fixed relative to said bearing arrangement in the axial direction of said wheel;
a second shoulder fixed relative to said wheel in the axial direction of said wheel, an axially extending space being defined between said shoulders; and
a braking mechanism responsive to the narrowing of said space to brake said wheel, said wheel being axially movable relative to said bearing arrangement between a first position, in which said space is relatively narrow and said braking mechanism is engaged, and a second position, in which said space is relatively wide and said braking mechanism is disengaged.

2. The brake system for wheeled skates according to claim 1, wherein said brake mechanism comprises a plurality of brake disks mounted in said space to be axially slidable in said space.

3. The brake system for wheeled skates according to claim 2, wherein at least a first one of said disks is coupled to rotate with said wheel and at least a second one of said disks is coupled such that said at least one second disk cannot rotate with said wheel.

4. The brake system for wheeled skates according to claim 3, further comprising a spring positioned to bias said wheel toward said second position, in which said space is relatively wide and said braking mechanism is disengaged.

5. The brake system for wheeled skates according to claim 4, wherein said spring has a predetermined threshold force that is required to be overcome before the spring begins deforming to allow movement of said wheel toward said first position, in which said space is relatively narrow and said braking mechanism is engaged.

6. The brake system for wheeled skates according to claim 4, wherein said spring comprises a thin elliptical element that is “C” shaped as viewed along the major axis of the ellipse.

7. The brake system for wheeled skates according to claim 3, wherein a plurality of first disks are coupled to rotate with said wheel, and a plurality of second disks are coupled such that said second disks cannot rotate with said wheel and are interleaved with said first disks.

8. The brake system for wheeled skates according to claim 3, wherein said first shoulder is on a spacer element, the spacer element is fixed to said bearing arrangement, and said at least a second one of said disks is coupled to said spacer element.

9. The brake system for wheeled skates according to claim 8, wherein said disks have non-circular apertures, said spacer element has a non-circular outer surface that is complementary to said apertures, and said non-circular outer surface is received in said apertures.

10. The brake system for wheeled skates according to claim 9, wherein said second shoulder is on an element fixed to the wheel.

11. The brake system for wheeled skates according to claim 1, wherein said first shoulder is on a spacer element, and the spacer element is fixed to said bearing arrangement.

12. The brake system for wheeled skates according to claim 11, further comprising a first threaded fastener received in threaded engagement with said spacer element on one side of said spacer element along the axis of rotation of the wheel, and a second threaded fastener received in threaded engagement with said spacer element on an opposite side of said spacer element along the axis of rotation of the wheel, said threaded fasteners being adapted to fix said spacer element to a skate frame, whereby any tendency of said spacer element to rotate is resisted by tightening of one of the threaded fasteners in said spacer element.

13. The brake system for wheeled skates according to claim 1, wherein the wheel is mounted for axial movement relative to said bearing arrangement.

14. The brake system for wheeled skates according to claim 1, wherein the wheel is mounted for axial sliding on said bearing arrangement.

15. The brake system for wheeled skates according to claim 14, wherein said bearing arrangement has outer surfaces, and the wheel is mounted for axial sliding on said outer surfaces.

16. The brake system for wheeled skates according to claim 1, wherein the wheel has an outer surface and a recess on each side of the wheel along the axis of rotation of the wheel, and said bearing arrangement comprises a first bearing positioned in the recess in the inside of the wheel, with respect to the foot of the skater, and a second bearing positioned in the recess on the opposite side of the wheel, said first bearing being entirely accommodated within its associated recess.

17. The brake system for wheeled skates according to claim 1, further comprising a spacer element, wherein said bearing arrangement comprises two bearings, and said spacer element is positioned between and in contact with said bearings, said spacer element keeping said bearings spaced from one another.

18. The brake system for wheeled skates according to claim 17, wherein said bearings have axially outer surfaces, and said spacer element keeps the axially outer surfaces of said bearings spaced from one another by a distance less than 25 mm.

19. The brake system for wheeled skates according to claim 17, wherein said bearings have axially outer surfaces, and said spacer element keeps the axially outer surfaces of said bearings spaced from one another by a distance less than the distance between inward facing surfaces of a standard skate frame.
